(19) United States
(12) Patent Application Publication
(10) Pub. No.: US 2007/0236412 A1
(43) Pub. Date: Oct. 11, 2007

(54) Organic Electro Luminescence Display Driving Circuit for Shielding a Row-Line Flashing

(76) Inventors: Chang Oon Kim, Yongin-si (KR); Young Seok Sohn, Yongin-si (KR)

Correspondence Address: FENWICK & WEST LLP, SILICON VALLEY CENTER, 801 CALIFORNIA STREET, MOUNTAIN VIEW, CA, 94041, US

(21) Appl. No.: 10/586,887

(22) PCT Filed: Jan. 31, 2004
(86) PCT No.: PCT/KR04/00178

§ 371 Date: Jul. 20, 2006

(51) Int. Cl. G09G 3/12

(52) U.S. Cl. 345/45

(57) ABSTRACT

Disclosed is an organic electro luminescence display driving circuit. According to the present invention, it is possible to prevent a generation of a row-line flashing, which may happen when a display signal from a display signal terminal enters the organic electro luminescence display driving circuit. The organic electro luminescence display driving circuit for shielding a row-line flashing according to the present invention includes a real display signal generating circuit, which is connected to a display signal terminal and a pre-signal terminal, for providing a bias circuit for column driving circuit and row-line bias circuit with a real display signal.

### TECHNICAL FIELD

The present invention relates to an organic electroluminescence (EL) display driving circuit. More particularly, the present invention relates to an organic EL display driving circuit for shielding a row line flashing which may occur when a display signal enters the organic EL display driving circuit.

### BACKGROUND ART

Organic EL display is a flat panel display using luminescence phenomenon that organic luminescent material itself emits light as electrons and holes of the organic luminescent material combine together under electric field applied from outside. Accordingly, as compared with a liquid crystal display, the organic EL display has a superior viewing angle and a contrast, the organic EL display is advantageously manufactured to be a light and flat form because a backlight is not required, and the organic EL display has a low consumption power and a high brightness. In addition, since it weighs light and it has a rapid reaction rate, it is evaluated to be a next generation display which can be used in most electronic applications such as a mobile communication terminal, a PDA, a camcorder, and a palm PC, etc.

The organic EL display is classified into a high molecular type and a low molecular type according to a material forming an organic substance, and into a passive matrix type and an active matrix type according to a driving mode.

FIG. 1 shows an organic EL display driving circuit according to the prior art in display-on mode. An organic EL display panel 11 consists of a plurality of pixels each of which is operated by a pixel operating circuit 12 consisting of a diode and a capacitor. A column driving circuit, i.e., c(n−1), c(n), c(n+1) and c(n+2), . . . , etc. is connected to an anode terminal of the diode of the pixel operating circuit, and a row voltage supply circuit consisting of switching circuits for supplying a ground or source voltage (VCC) to each row is connected to a cathode terminal of the diode. The row voltage supply circuit selects a row line to be driven by applying the supply voltage or ground voltage to the cathode terminal of the diode of the each pixel operating circuit, thereby serving as a row driving circuit. The column driving circuit comprises a bias circuit for generating a current source, a part current-driven by the bias circuit and a part for separating outputs of each column by connecting or disconnecting a ground or previously charged voltage of a pre-signal terminal.

FIG. 2 shows an organic EL display driving circuit according to the prior art in display-off mode. The column driving circuit of the organic EL display driving circuit in display-off mode is under Hi-Z state in which the circuit is not operated, and a row output is connected with a ground voltage, so that the current does not flow in the diode of the pixel operating circuit. Accordingly, the organic EL display panel 11 comes to be in display-off mode.

FIG. 3 shows a driving timing of an organic EL display driving circuit according to the prior art in display-off mode. Under state that the organic EL display driving circuit is off as shown in FIG. 2, when it makes the circuit be turned on, a column driving circuit should maintain the Hi-Z state until display data is prepared and then drive the column from the moment the display data is prepared. However, according to the prior art, when the display signal enters the organic EL display driving circuit in display-off mode, a voltage pumping occurs by capacitance component of the organic EL display panel, the voltage pumping having a voltage magnitude supplied during normal display condition, so that it would be similar situation that a voltage is supplied to the column driving circuit. In addition, since the ground voltage is connected to the row line in display-off mode, current flows into the diode of the pixel operating circuit, so that a row line flashing, which the row line twinkles, occurs.

### DISCLOSURE OF INVENTION

Accordingly, the present invention has been made to solve the above-mentioned problems occurring in the prior art. As described above, since a voltage is applied to a column driving circuit before display data is prepared after an entrance of a display signal, a row line flashing, which deteriorates an embodying quality of an organic EL display, occurs. Thus, the object of the present invention is to structure an organic EL display driving circuit such that a voltage is applied to a column driving circuit when display data is prepared after a display signal enters the organic EL display driving circuit.

In this specification including the claims, a term of ‘display signal’ means a signal entering the organic EL display driving circuit from a display signal terminal, as a result of operation that a user of an organic EL display drives the organic EL display. A term of ‘real display signal’ means a signal generated from a real display signal generating circuit provided in an organic EL display driving circuit according to the present invention, which is different from a signal inputted from an exterior.

In order to accomplish the objects, there is provided an organic EL display driving circuit shielding a row line flashing, comprising a real display signal generating circuit, connected to a display signal terminal and a pre-signal terminal, for supplying a real display signal to a bias circuit of a column driving circuit and a row voltage supply circuit.

It is preferred that the real display signal generating circuit generates the real display signal from the moment a pre-signal is initially inputted from the pre-signal terminal after a display signal is inputted from the display signal terminal.

### BRIEF DESCRIPTION OF THE DRAWINGS

The above and other objects, features and advantages of the present invention will be more apparent from the following detailed description taken in conjunction with the accompanying drawings, in which:

FIG. 1 shows an organic EL display driving circuit according to the prior art in display-on mode;

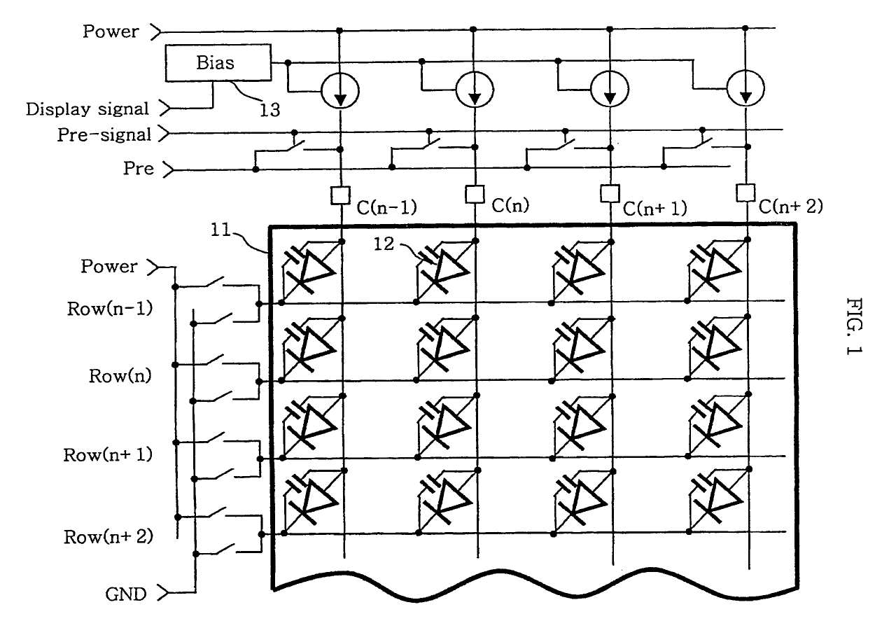

FIG. 2 shows an organic EL display driving circuit according to the prior art in display-off mode;

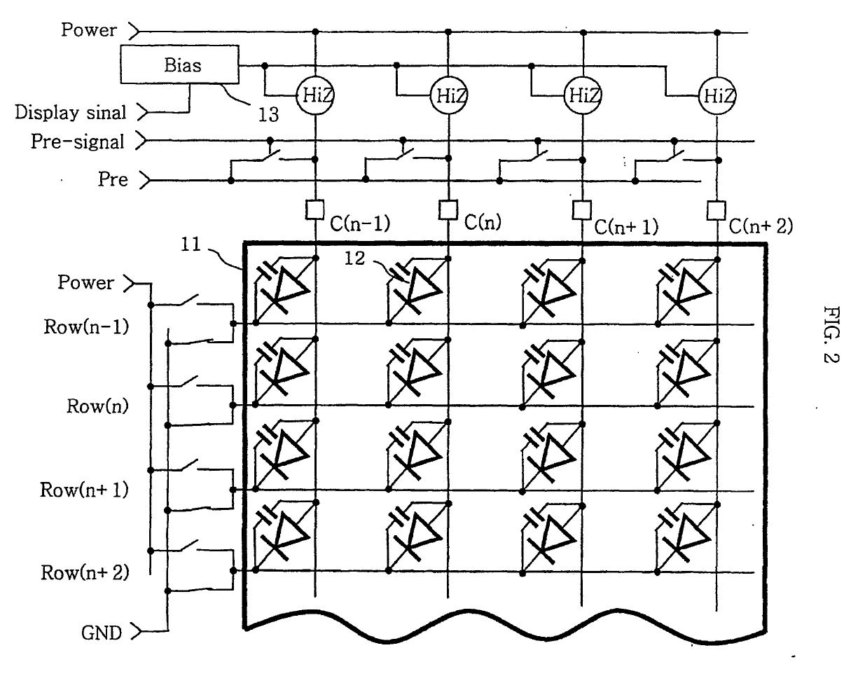

FIG. 3 shows a driving timing of an organic EL display driving circuit according to the prior art;

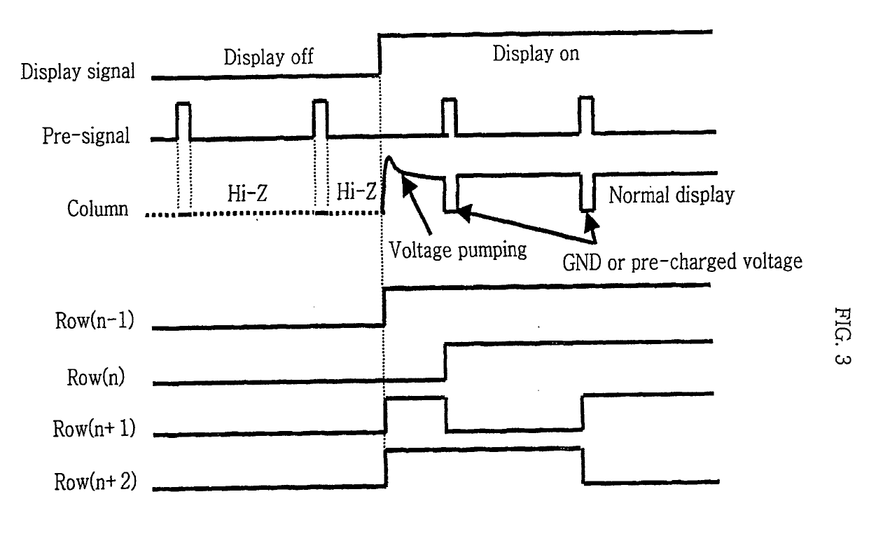

FIG. 4 shows an organic EL display driving circuit shielding a row line flashing according to an embodiment of the present invention; and

FIG. 5 shows a driving timing of an organic EL display driving circuit shielding a row line flashing according to an embodiment of the present invention.

### BEST MODE FOR CARRYING OUT THE INVENTION

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

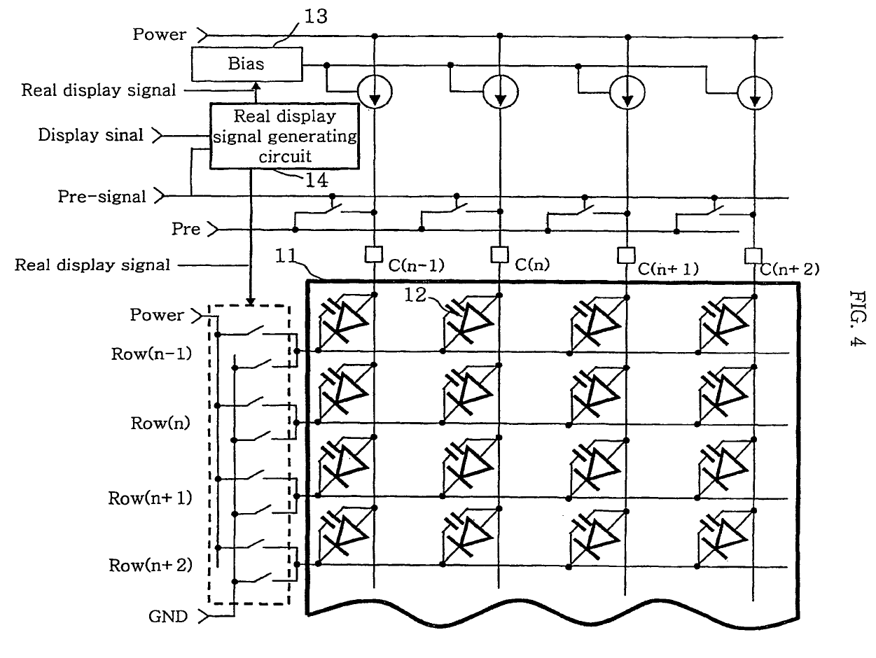

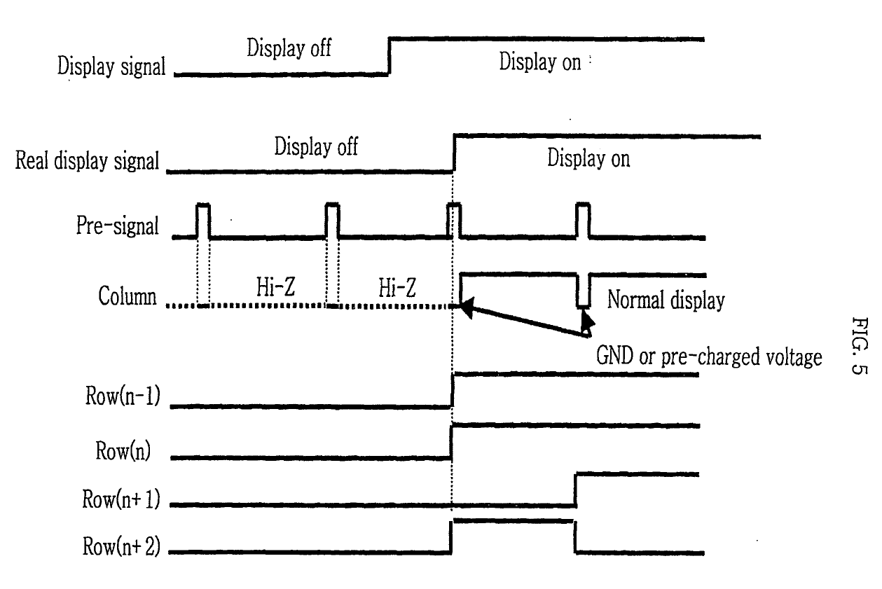

FIG. 4 shows an organic EL display driving circuit shielding a row line flashing according to an embodiment of the present invention, and FIG. 5 shows a driving timing of an organic EL display driving circuit shielding a row line flashing according to an embodiment of the present invention. The organic EL display driving circuit shielding a row line flashing according to the present invention comprises a real display signal generating circuit connected to a display signal terminal and a pre-signal terminal, thereby supplying a real display signal to a bias circuit of a column driving circuit and a row voltage supply circuit. The real display signal generating circuit is operated according to driving timings of a display signal and a pre-signal. A generation of the real display signal depends on whether the display signal and the pre-signal are inputted or not. In other words, the real display signal is generated when the pre-signal is initially inputted after the display signal is inputted.

Referring to a driving timing shown in FIG. 5, the display signal is inputted under state that an on/off of the pre-signal is periodically repeated, and the real display signal is generated from the real display signal generating circuit when the pre-signal is initially on after the display signal is inputted. After the real display signal is generated, a column driving circuit is normally operated. Thus, current is supplied by the bias circuit and source voltage is applied to an anode terminal of a diode of each pixel driving circuit.

From the moment the real display signal is generated, a row driven according to switching of the row voltage supply circuit can be selected. For example, in FIG. 5, the row (n−1) and the row (n) are display-on from the moment the real display signal is generated, and the row (n+1) is display-on from a one on-off period of the pre-signal immediately after the real display signal is generated.

### INDUSTRIAL APPLICABILITY

As described above, the organic EL display driving circuit according to the present invention comprises a real display signal generating circuit, so that it does not immediately respond even though a display signal is inputted and the organic EL display circuit is operated by a real display signal generated from the real display signal generating circuit. Accordingly, it is possible to shield a row line flashing that the row line twinkles in advance.

What is claimed is:

1. An organic electroluminescence (EL) display driving circuit shielding a row line flashing, comprising a real display signal generating circuit, connected to a display signal terminal and a pre-signal terminal, for supplying a real display signal to a bias circuit of a column driving circuit and a row voltage supply circuit.

2. The organic EL display driving circuit shielding a row line flashing according to claim 1, wherein the real display signal generating circuit generates a real display signal from the moment a pre-signal is initially inputted from the pre-signal terminal after a display signal is inputted from the display signal terminal.
